(19) United States
(12) Patent Application Publication
(10) Pub. No.: US 2010/0057761 A1
(43) Pub. Date: Mar. 4, 2010

(54) Method, apparatus, computer program and user interface for enabling user input

(75) Inventors: Jesper Nolhage, Kobenhavn S (DK); Catherine Joergensen, Copenhagen (DK)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/231,356

(22) Filed: Sep. 2, 2008

(51) Int. Cl. G06F 17/30

(52) U.S. Cl. 707/101; 707/E17.009

(57) ABSTRACT

A method, apparatus, computer program and user interface wherein the method includes: presenting an image on a display; editing the image in response to detection of user input to create an edited image; automatically creating a data file, defining the edited image, in an accessible location such that the data file can be subsequently referenced and retrieved; detecting user selection of a function to be performed in relation to the edited image; and in response to the detection of the user selection of the function, automatically referencing and retrieving the data file of the edited image from the accessible location for use in relation to the selected function.

### FIELD OF THE INVENTION

Embodiments of the present invention relate to a method, apparatus, computer program and user interface for enabling user input. In particular, they relate to a method, apparatus, computer program and user interface for enabling user input in relation to an edited image.

### BACKGROUND TO THE INVENTION

Devices which enable a user to edit images such as digital photographs are known. There are many ways in which such devices enable images to be edited. For example a user of the device may be able to enlarge or rotate an image so that the image may be viewed more easily. The user may also be able to adjust settings of the image such as the colour or brightness to improve the quality of the image or for aesthetic purposes.

Once an image has been edited it is useful to enable a function to be performed in relation to that image.

### BRIEF DESCRIPTION OF VARIOUS EMBODIMENTS OF THE INVENTION

According to various, but not necessarily all, embodiments of the invention there is provided a method comprising: presenting an image on a display; editing the image in response to detection of a user input to create an edited image; automatically creating a data file, defining the edited image, in an accessible location such that the data file can be subsequently referenced and retrieved; detecting user selection of a function to be performed in relation to the edited image; and in response to the detection of the user selection of the function, automatically referencing and retrieving the data file of the edited image from the accessible location for use in relation to the selected function.

The data file may be automatically created in response to detection that an edited image has been created, for example, the data file may be created in response to the detection of the user input which edits the image. Alternatively the data file may be automatically created in response to the user selection of the function. In other embodiments of the invention the data file may be automatically created, defining the image presented on the display, at scheduled intervals.

In some embodiments of the invention the file defining the edited image may be automatically assigned a file name and stored in a file storage system. The data file defining the edited image may be a compressed image file. The compressed image file may be created using a standard format such as JPEG (Joint Photographic Expert Group).

In some embodiments of the invention the edited image defined by the data file may correspond to the edited image that is presented on the display after the editing has occurred.

In some embodiments of the invention the image may be edited by modifying the image presented on the display. For example the image may be modified by rotating the image or enlarging the image or reducing the size of the image.

In some embodiments of the invention the function performed may be to use the edited image as a background image or an identity tag. In other embodiments of the invention the function performed may be to send the edited image or to print the edited image. In embodiments where the function performed is printing or sending the edited image the data file defining the edited image may be automatically deleted once the function has been performed.

In some embodiments of the invention the data file defining the edited image is automatically created without any additional user input.

According to various, but not necessarily all, embodiments of the invention there is provided an apparatus comprising: a display configured to present images; a user input device configured to enable a user of the apparatus to edit an image presented on the display to create an edited image and a user input device configured to enable a user to select a function to be performed in relation to the edited image; and a controller configured to automatically create a data file, defining the edited image, in an accessible location such that the data file can be subsequently referenced and retrieved and the controller is also configured to detect the user selection of a function to be performed in relation to the edited image and, in response to detection of the user selection of the function, automatically reference and retrieve the data file of the edited image from the accessible location for use in relation to the selected function.

In some embodiments of the invention the user input device configured to enable a user to edit an image may also be configured to enable a user to select a function to be performed on an edited image.

In other embodiments of the invention the user input device configured to enable a user to edit an image may be different to the user input device configured to enable a user to select a function to be performed on an edited image. For example, the user input device configured to enable a user to edit an image may be a device which can determine the orientation of the apparatus or a rotation of the apparatus such as an accelerometer.

According to various, but not necessarily all, embodiments of the invention there is provided a computer program comprising program instructions for controlling an apparatus, the apparatus comprising a display configured to present images and a user input configured to enable a user of the apparatus to edit an image presented on the display to create an edited image and a user input device configured to enable a user to select a function to be performed in relation to the edited image, the program instructions providing, when loaded into a processor; means for automatically creating a data file, defining the edited image, in an accessible location such that the data file can be subsequently referenced and retrieved; means for detecting user selection of a function to be performed in relation to the edited image; and means for, automatically referencing and retrieving, in response to the detection of the user selection of the function, the data file of the edited image from the accessible location in relation to the selected function.

According to various, but not necessarily all, embodiments of the invention there is provided a user interface comprising: a display configured to present images; a user input device configured to enable a user to edit an image presented on the display to create an edited image and a user input device configured to enable a user to select a function to be performed in relation to the edited image; wherein a data file, defining the edited image, is automatically created in an accessible location such that the data file can be subsequently referenced and retrieved; and, in response to user selection of a function to be performed in relation to the edited image, the data file of the edited image is automatically referenced and retrieved from the accessible location for use in relation to the selected function.

According to various, but not necessarily all, embodiments of the invention there is provided a method comprising: presenting an image on a display; editing the image in response to user input to create an edited image and presenting the edited image on the display; detecting user selection of a send function to be performed in relation to the edited image; and, in response to the user selection of the send function; sending the edited image without further user input to store the edited image.

In some embodiments of the invention the send function may be sending the edited image via email, multimedia message or a low power communications message such as a Bluetooth message.

According to various, but not necessarily all, embodiments of the invention there is provided an apparatus comprising: means for presenting an image; means for enabling a user to edit an image to create an edited image; means for enabling a user to select a send function to be performed on the edited image; and means for sending the edited image without further user input to enable the edited image to be stored.

The apparatus may be for wireless communication.

### BRIEF DESCRIPTION OF THE DRAWINGS

For a better understanding of various examples of embodiments of the present invention reference will now be made by way of example only to the accompanying drawings in which:

FIG. 1 schematically illustrates an electronic apparatus;

FIG. 2 illustrates a flow chart showing method blocks of an embodiment of the present invention; and

FIGS. 3A to 3D illustrate a graphical user interface according to a first embodiment the present invention.

### DETAILED DESCRIPTION OF VARIOUS EMBODIMENTS OF THE INVENTION

The Figures illustrate a method comprising: presenting 31 an image 51 on a display 17; editing 33 the image 51 in response to detection of a user input to create an edited image 51A, 51B, 51C; automatically creating 35 a data file 11, defining the edited image 51A, 51B, 51C, in an accessible location 13 such that the data file 11 can be subsequently referenced and retrieved; detecting 37 user selection of a function to be performed in relation to the edited image 51A, 51B, 51C; in response to the detection 37 of the user selection of the function, automatically referencing and retrieving 39 the data file 11 of the edited image 51A, 51B, 51C from the accessible location 13 for use in relation to the selected function.

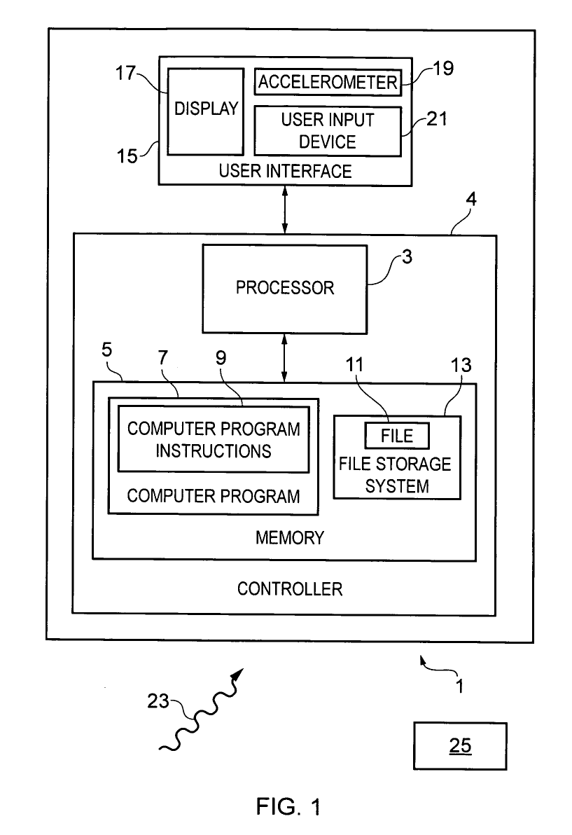

FIG. 1 schematically illustrates an apparatus 1. The apparatus 1 may be an electronic apparatus. Only features referred to in the following description are illustrated. It should, however, be understood that the apparatus 1 may comprise additional features that are not illustrated. The apparatus 1 may be, for example, a personal computer, a camera, a personal digital assistant, a mobile cellular telephone, or any other apparatus that enables a user to store and edit images. The apparatus 1 may be a handheld apparatus 1 which can be carried in a user's hand, handbag or jacket pocket for example.

The illustrated apparatus 1 comprises: a user interface 15, and a controller 4. In the illustrated embodiment the controller 4 comprises a processor 3 and a memory 5.

The controller 4 may be implemented using instructions that enable hardware functionality, for example, by using executable computer program instructions 9 in a general-purpose or special-purpose processor 3 that may be stored on a computer readable storage medium (e.g. disk, memory etc) to be executed by such a processor 3.

The processor 3 is configured to receive input commands from the user interface 15 and also to provide output commands to the user interface 9. The processor 3 is also configured to write to and read from the memory 5.

In the illustrated embodiment the user interface 15 comprises a display 17 and user input devices 19, 21.

The display 17 is configured to present images 51. The images 51 may be edited in response to actuation of the user input devices 19, 21 to create edited images 51A, 51B, 51C. The display 17 is also configured to present the edited images 51A, 51B, 51C.

The display 17 may also be configured to present a list of selectable options to a user, for example, a list of functions which may be performed in relation to an edited image 51A, 51B, 51C may be presented on the display 17.

The user input device 21 may be a touch pad, a key pad, a joy stick, a touch sensitive area of the display 17 or any other user input device which enables a user of the apparatus 1 to input information which can be used to edit an image 51 or select a function of the apparatus 1. In some embodiments of the invention the user input device 21 may comprise programmable keys 53, 55, 57 and a directional key 59. The functions of the programmable keys 53, 55, 57 may depend upon the mode of operation of the apparatus 1. The functions associated with the programmable keys 53, 55, 57 may be configured so that the programmable keys 53, 55, 57 may be used both for editing an image 51 and selecting a function to be performed in relation to an edited image 51A, 51B, 51C. The directional key 59 may also be programmable so that the particular function associated with the directional key 59 also depends on the mode of operation of the apparatus 1.

The user input device 19 may enable a user to edit an image 17. For example the user input device 19 may be a device such as an accelerometer which is configured to detect the orientation of the apparatus 1 or a movement of the apparatus 1 such as a rotation and edit an image 51 in response to the detection.

In the illustrated embodiment of the invention both the user input device 19 and the user input device 21 are configured to enable a user to edit an image 51. In other embodiments of the invention only one the user input devices 19, 21 may be configured to enable an image 51 to be edited.

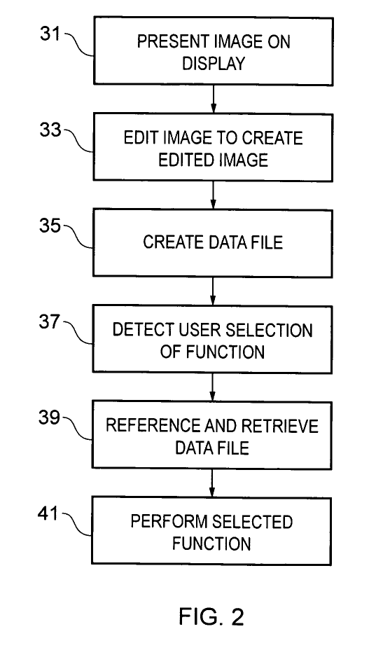

The memory 5 stores a computer program 7 comprising computer program instructions 9 that control the operation of the apparatus 1 when loaded into the processor 3. The computer program instructions 9 provide the logic and routines that enables the apparatus 1 to perform the method illustrated in FIG. 2. The processor 3 by reading the memory 5 is able to load and execute the computer program 7.

The computer program instructions 9 may provide computer readable program means for editing an image 51 in response to user input to create an edited image 51A, 51B, 51C. The computer program instructions 9 may also provide computer readable program means for controlling the display 17 to present the edited image 51A, 51B, 51C on the display 17.

The computer program instructions 9 may also provide computer readable program means for automatically creating 35 a data file 11 defining the edited image 51A, 51B, 51C in an accessible location 13 such that the data file 11 can be subsequently referenced and retrieved, means for detecting 37 user selection of a function to be performed in relation to the edited image 51A, 51B, 51C; and means for, automatically referencing and retrieving 39, in response to the detection 37 of the user selection of the function, the data file 11 of the edited image 51A, 51B, 51C from the accessible location 13 in relation to the selected function.

The computer program 7 may arrive at the apparatus 1 via any suitable delivery mechanism 23. The delivery mechanism 23 may be, for example, a computer-readable storage medium, a computer program product 25, a memory device, a record medium such as a CD-ROM or DVD, an article of manufacture that tangibly embodies the computer program 7. The delivery mechanism may be a signal configured to reliably transfer the computer program 7. The apparatus 1 may propagate or transmit the computer program 7 as a computer data signal.

Although the memory 5 is illustrated as a single component it may be implemented as one or more separate components some or all of which may be integrated/removable and/or may provide permanent/semi-permanent/ dynamic/cached storage.

The memory may comprise an accessible location 13 in which the automatically created data file 11 defining the edited image may be located. The accessible location 13 may be, for example, a file storage system. Each file in the file storage system may be assigned a file name and stored logically within the file storage system.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (e.g. Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

A method of controlling the apparatus 1, according to an embodiment of the present invention, is illustrated schematically in FIG. 2.

At block 31 an image 51 is presented on the display 17. The image 51 may be an image which has been received by the apparatus 1, for example, it may have been downloaded from a website or received by the apparatus 1 in a message such as an email, a multimedia message or a low power radio communication message such as a Bluetooth message.

The image 51 may be stored in the memory 5. The image 51 may be stored as a compressed image file. The image 51 may be stored in accordance with a standard format such as JPEG.

At block 33 the image 51 is edited in response to detection of a user input to create an edited image 51A, 51B, 51C. The user input may be made using one or both of the user input devices 19, 21. The edited image 51A, 51B, 51C may be presented on the display 17. The edited image 51A, 51B, 51C may replace the original image 51 on the display 17.

The image 51 may be edited by modifying the image presented on the display 17. For example the image 51 may be modified by rotating the image 51. The user input which enables the image 51 to be rotated may be physical rotation of the apparatus 1 which is detected by the accelerometer 19. The direction in which the apparatus 1 is rotated may determine the direction in which the image 51 is rotated. The angle through which the apparatus 1 is rotated may determine the angle through which the image 51 is rotated.

This provides a simple and user intuitive method of enabling an image to be edited.

In other embodiments the image 51 may be rotated in response to actuation of a key such as the directional key 59 and the direction in which the image 51 is rotated may be determined by the part of directional key 59 which is actuated.

The image 51 may also be edited by enlarging the image 51. The image may be enlarged using one of the keys 53, 55, 57, 59, of the user input 21 for example, the directional key 59. When the image 51 is enlarged only a portion of the image 51A, 51B, 51C may be presented on the display 17. The apparatus 1 may be configured to enable a user to change the portion of the image 51 which is presented on the display 17 using the user input 21.

The image 51 may also be edited by reducing the size of the image 51 presented on the display 17. When the edited image 51A, 51B, 51C is created by reducing the size of the image 51 some portions of the image 51 which were not originally presented on the display 17 may be presented after the image 51 has been reduced.

The image 51 may also be edited by modifying the colour of the image 51, for example by changing from a colour image to a black and white image or vice versa.

The image 51 may also be edited by modifying settings of the image such as the brightness dr contrast of the image 51.

In some embodiments of the invention the image 51 may also be edited by adding a label or a tag to the image 51. For example the label may be added to indicate what features in the image 51 are, for example, where the image 51 is a picture of a group of people a label may be added identifying the people in the image 51.

At block 35 a data file 11 is automatically created. The data file 11 defines the edited image 51A, 51B, 51C and corresponds to the image which is presented on the display 17 after the editing has occurred.

The data file 11 is a discrete unit of data which is capable of being manipulated as an entity. For example, it may be transferred between memory locations or it may be used by application programs to enable functions to be performed in relation to the edited image 51A, 51B, 51C. The data file 11 may be assigned name which uniquely identifies the data file 11. In some embodiments of the invention the data file may be a compressed image file such as a JPEG file.

The data file 11 is stored in an accessible location 13 such that it can be referenced and retrieved. For example the data file 11 may be stored in a file storage system 13. The file storage system 13 may specify the name assigned to the data file 11 and the format of the data file 11. The data file 11 may be retrieved from the accessible location 13 and manipulated so that functions can be performed in relation to the edited image 51A, 51B, 51C.

At block 37 the controller 4 detects user selection of a function of the apparatus 1. The user may select a function using the user input device 21, for example by actuating a programmable key 53, 55, 57. In some embodiments of the invention the user may select the function from a list of available functions which may be presented on the display 17 as a list of user selectable options. In other embodiments of the invention each of the programmable keys 53, 55, 57 may be associated with a different function.

In response to the user selection of the function the controller 4 references and retrieves the stored data file 11. For example the controller 4 will access the location 13 where the data file 11 is stored and retrieve the data file 11 to enable a function to be performed in relation to the edited image 51A, 51B, 51C.

At block 41 the selected function is performed in relation to the edited image 51A, 51B, 51C. The selected function may be one or more of a large number of functions.

In some embodiments of the invention the function may be sending the edited image 51A, 51B, 51C. The edited image 51A, 51B, 51C may be sent as an email message, as a multimedia message or as a low power radio communication message such as a Bluetooth message.

In some embodiments of the invention the function may be printing the edited image 51A, 51B, 51C.

In embodiments where the selected function is sending or printing the edited image 51A, 51B, 51C the data file 11 defining the edited image 51A, 51B, 51C may be automatically deleted once function has been performed. The controller 4 may wait until a confirmation message is received confirming that the function has been successfully completed before deleting the data file 11.

The selected function may be using the edited image 51A, 51B, 51C to personalize the apparatus 1. For example, the function may be to use the edited image 51A, 51B, 51C as a background image such as wallpaper or a screen saver. The function may also be to use the edited image 51A, 51B, 51C as caller identification or to include with a set of contact details.

The blocks illustrated in the FIG. 2 may represent steps in a method and/or sections of code in the computer program 7. The illustration of a particular order to the blocks does not necessarily imply that there is a required or preferred order for the blocks and the order and arrangement of the block may be varied. Furthermore, it may be possible for some steps to be omitted.

For example, in the embodiments illustrated in FIG. 2 the data file 11 is automatically created after the image 51 has been edited. This may be in response to detection that the image 51 has been edited or it may be automatically created at scheduled intervals. In other embodiments the data file 11 may be created in response to the detection that a user has selected a function to be performed on the edited image 51A, 51B, 51C.

As the data file 11 is created automatically there is no need for a user input to save the edited image or to indicate where the edited image should be stored or to assign a file name to the edited image. This makes performing functions in relation to the edited images quicker, easier and more user intuitive. It also simplifies the procedure for the user as they do not have to be concerned with the details of how and where the image is saved.

In embodiments where the data file 11 is automatically deleted once the function has been successfully completed, this provides the advantage that the edited images which are no longer needed are not using up the memory 5. This also removes the requirement for the user to have to delete unwanted images from the memory 5 which can be time consuming and laborious.

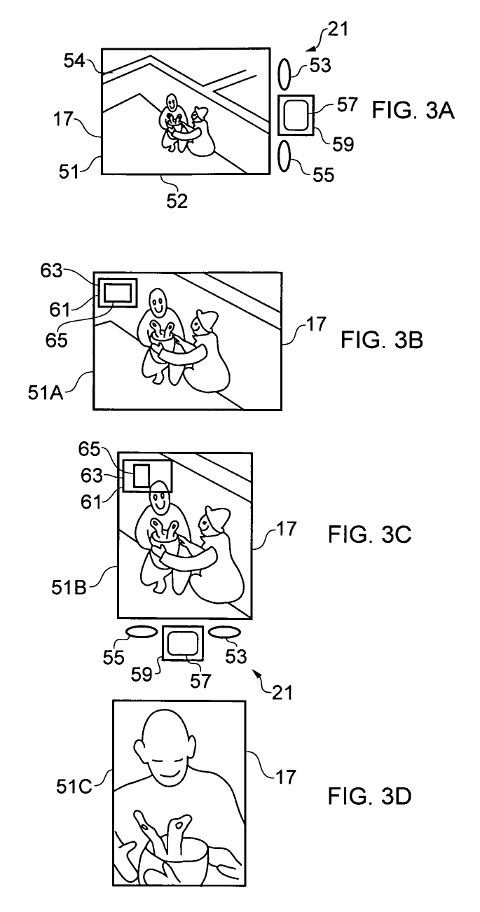

FIGS. 3A to 3D illustrate a graphical user interface according to embodiments of the invention. In FIG. 3A an image 51 is presented on the display 17. The display 17 is rectangular having a length 52 and a width 54 where the length 52 is longer than, and perpendicular to, the width 54. In FIG. 3A the apparatus 1 is positioned such that the display 17 is in landscape orientation with the length substantially horizontal.

The image 51 is presented on the display 17 in landscape orientation such that it is in the correct orientation for viewing and all the features in the image are in the correct orientation.

A user input device 21 is located adjacent to the display 17. In the embodiment illustrated the user input device 21 comprises three programmable keys positioned along the width 54 of the display 17 so that there is a right hand programmable key 53, a left hand programmable key 55 and these are positioned either side of a middle programmable key 57. As the display 17 is in landscape orientation the programmable keys 53, 55, 57 are located in a substantially vertical line so that the left hand programmable key 55 is positioned underneath the right hand programmable key 53. The user input device 21 also comprises a directional key 59. In the illustrated embodiment the directional key 59 is located surrounding the middle programmable key 57 so that the middle programmable key 57 is located in the center of the directional key 59.

The image 51 is quite small and it is hard to view the details of the image 51. this makes the image unsuitable for use as a background image such as wallpaper and the user may not consider it to be worth the expense of sending as a message.

In FIG. 3B the user has edited the image 51 by enlarging it to create the edited image 51A. As the original image 51 has been enlarged only a portion of the original image 51 can be presented on the display 17 because the scale of the image 51A has increased relative the size of the display 17. The user may have enlarged the image by actuating an appropriate key in the user input device 21. For example the vertical directions of the directional key 59 may enable a user to decrease and increase the size of the image 51 presented on the display 17.

In FIG. 3B only a portion of the original image 51 is presented on the display 17. An icon 61 is presented which indicates the portion of the original image which is currently being presented. The icon 61 comprises a first rectangle 63 and a second rectangle 65 located within the first rectangle 63. The first rectangle 63 represents the original image 51, as illustrated in FIG. 3A and the second rectangle 65 indicates the portion of the original image 51 which is currently being displayed in FIG. 3B. The user input device 21 may enable the user of the apparatus 1 to control which portion of the original image is presented. For example the directional user input key 59 may be used to scroll up or down with respect to the original image 51.

In FIG. 3C the user has edited the image 51A by rotating the image 51A to create a new edited image 51B. In the example illustrated the user has rotated the image by rotating the apparatus 1 so that the display is now in portrait orientation with the width substantially horizontal. An accelerometer 19 detects that the apparatus 1 has been rotated and rotates the image 51A accordingly to create the edited image 51B. As the image 51A is rotated when the apparatus 1 is rotated the features of the image 51A remain in the correction orientation for viewing by the user of the apparatus 1.

The icon 61 also indicates that the edited image has been rotated relative to the original image 51 as the inner rectangle 65 is now also presented in portrait orientation but the outer rectangle 63 remains in landscape orientation as this is the orientation of the original image 51.

In FIG. 3D the user has created a further new edited image 51C by enlarging the image 51B. As mentioned above this may be done by actuating the user input 21.

The user now has an edited image 51C in which the main subject of the image 51C can be clearly seen. The image 51C is now suitable for use as a background image or may be sent as a message.

As the controller 4 is configured to automatically create 35 a data file 11 defining the edited image 51C, in order to perform a function in relation to the edited the image 51C the user only needs to make a user input to select the function. For example a user may actuate the programmable keys 53, 5, 57 of the apparatus 1 to access a list of functions which may be selected. Once this has been selected the function can be performed without any additional inputs from the user.

There is no requirement for the user to manually save the edited image 51C. This makes the process much simpler and more intuitive for the user. It also means that the user does not have to be concerned with the details of how and where the edited images are stored which is advantageous because users may find this complicated or uninteresting.

Although embodiments of the present invention have been described in the preceding paragraphs with reference to various examples, it should be appreciated that modifications to the examples given can be made without departing from the scope of the invention as claimed. For example there are many ways of editing images which are well known and any of these may be used to edit an image in the present invention. There are also many other functions which may be performed in relation to the edited images.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A method comprising:
presenting an image on a display;
editing the image in response to detection of a user input to create an edited image;
automatically creating a data file, defining the edited image, in an accessible location such that the data file can be subsequently referenced and retrieved;
detecting user selection of a function to be performed in relation to the edited image; and
in response to the detection of the user selection of the function, automatically referencing and retrieving the data file of the edited image from the accessible location for use in relation to the selected function.

2. A method as claimed in claim 1 wherein the file defining the edited image is automatically assigned a file name and stored in a file storage system.

3. A method as claimed in claim 1 wherein the data file defining the edited image is a compressed image file.

4. A method as claimed in claim 1 wherein the edited image defined by the data file corresponds to the edited image that is presented on the display after the editing has occurred.

5. A method as claimed in claim 1 wherein the image may be edited by modifying the image presented on the display by rotating the image or enlarging the image or reducing the size of the image.

6. A method as claimed in claim 1 wherein the function performed is to use the edited image as a background image or an identity tag.

7. A method as claimed in claim 1 wherein the function performed is to send the edited image.

8. A method as claimed in claim 1 wherein the function performed is to print the edited image.

9. A method as claimed in claim 7 wherein after the function has been performed the data file defining the edited image is automatically deleted.

10. A method as claimed in claim 1 wherein the data file defining the edited image is automatically created without any additional user input after the image has been edited.

11. An apparatus comprising:
a display configured to present images;
a user input device configured to enable a user of the apparatus to edit an image presented on the display to create an edited image and a user input device configured to enable a user to select a function to be performed in relation to the edited image; and
a controller configured to automatically create a data file, defining the edited image, in an accessible location such that the data file can be subsequently referenced and retrieved and the controller is also configured to detect the user selection of a function to be performed in relation to the edited image and, in response to detection of the user selection of the function, automatically reference and retrieve the data file of the edited image from the accessible location for use in relation to the selected function.

12. An apparatus as claimed in claim 11 wherein the user input device configured to enable a user to edit an image is also configured to enable a user to select a function to be performed on an edited image.

13. An apparatus as claimed in claim 11 wherein the user input device configured to enable a user to edit an image is different to the user input device configured to enable a user to select a function to be performed on an edited image.

14. An apparatus as claimed in claim 13 wherein the user input device configured to enable a user to edit an image is an accelerometer.

15. An apparatus as claimed in claim 11 wherein the file defining the edited image is assigned a file name and stored in a file storage system.

16. An apparatus as claimed in claim 11 wherein the data file defining the edited image is a compressed image file.

17. An apparatus as claimed in claim 11 wherein the edited image defined by the data file corresponds to the image that is presented on the display after the editing has occurred.

18. An apparatus as claimed in claim 11 wherein the image may be edited by modifying the image presented on the display by rotating the image or enlarging the image or reducing the size of the image.

19. An apparatus as claimed in claim 11 wherein the function performed is to use the edited image as a background image or an identity tag.

20. An apparatus as claimed in claim 11 wherein the function performed is to send the edited image.

21. An apparatus as claimed in claim 11 wherein the function performed is to print the edited image.

22. An apparatus as claimed in claim 20 wherein after the function has been performed the data file defining the edited image is deleted.

23. An apparatus as claimed in claim 11 wherein the controller is configured to automatically create the data file defining the edited image without any additional user input.

24. A computer program comprising program instructions for controlling an apparatus, the apparatus comprising a display configured to present images and a user input configured to enable a user of the apparatus to edit an image presented on the display to create an edited image and a user input device configured to enable a user to select a function to be performed in relation to the edited image, the program instructions providing, when loaded into a processor;
means for automatically creating a data file, defining the edited image, in an accessible location such that the data file can be subsequently referenced and retrieved;
means for detecting user selection of a function to be performed in relation to the edited image; and
means for, automatically referencing and retrieving, in response to the detection of the user selection of the function, the data file of the edited image from the accessible location in relation to the selected function.

25. A physical entity embodying the computer program as claimed in claim 24.

26. An electromagnetic carrier signal carrying the computer program as claimed in claim 24.

27. A user interface comprising:
a display configured to present images;
a user input device configured to enable a user to edit an image presented on the display to create an edited image and a user input device configured to enable a user to select a function to be performed in relation to the edited image;
wherein a data file, defining the edited image, is automatically created in an accessible location such that the data file can be subsequently referenced and retrieved; and in response to user selection of a function to be performed in relation to the edited image, the data file of the edited image is automatically referenced and retrieved from the accessible location for use in relation to the selected function.

28. A user interface as claimed in claim 27 wherein the user input device configured to enable a user to edit an image is also configured to enable a user to select a function to be performed on an edited image.

29. A user interface as claimed in claim 27 wherein the user input device configured to enable a user to edit an image is different to the user input device configured to enable a user to select a function to be performed on an edited image.

30. A user interface as claimed in claim 29 wherein the user input device configured to enable a user to edit an image is an accelerometer.
